(19) United States
(12) Patent Application Publication
(10) Pub. No.: US 2014/0203998 A1
(43) Pub. Date: Jul. 24, 2014

(54) COLOR COMPENSATION SYSTEM FOR DISPLAY DEVICE

(71) Applicant: SHAO-YANG WANG, NANTOU COUNTY (TW)

(72) Inventor: SHAO-YANG WANG, NANTOU COUNTY (TW)

(21) Appl. No.: 13/744,833

(22) Filed: Jan. 18, 2013

(51) Int. Cl. G09G 5/02

(52) U.S. Cl. CPC G09G 5/02
USPC 345/1.2

(57) ABSTRACT

A color compensation system for display devices is revealed. The color compensation system includes a server end and a user end electrically or optically connected to the server end by a transmission medium. The server end has a plurality of server-end display devices. A first processing unit electrically or optically connected to the server-end display devices, and a first storage unit electrically or optically connected to the first processing unit. Each server-end display device is electrically or optically connected to an optical measuring device for measuring image signal parameters of the connected server-end display device and transmitting SP to the first processing unit. The user end includes at least one user-end display device with a second processing unit. The second processing unit receives image signal compensation parameters through the transmission medium for performing compensation and adjustment of image signal changes caused by attenuation of the user-end display device.

### BACKGROUND OF THE INVENTION

1. Fields of the Invention

The current invention involves a color compensation system for a display device. This invention provides efficient and precise color compensation to adjust the displays for maintaining brightness and chromaticity synonymous with factory settings, maintaining the requirement of display color standards, or maintaining preference color settings of users.

2. Descriptions of Related Art

Generally, the light source (such as cold cathode fluorescent lamps or a light emitting diode) of electronics with displays (such as a television, a projector, a monitor, a handheld device, or a mobile device) attenuates after being used for a period of time. This problem results in minimizing brightness and a subsequent color shift in LED, LCD, OLED, AMOLED, etc. The attenuation is common due to optical and electrical characteristic degradation of LED materials, liquid crystal polymer materials, light sources, color filters, driving IC, and electronic components of panels. These shifts have negative effects on the image quality of the display and these are unacceptable to users. Moreover, the monitors that are used in the fields of advertising, art design, the printing and publishing industry, or medical diagnosis require a higher quality display unit (displays or monitors), and must have uniform brightness and coloring between different monitors and during different times in order to achieve the stable quality requirement. However, due to the attenuation of the display unit, users need to send the display back to the company for calibration, or they manually perform calibrations by themselves. Some users perform calibrations simply by a visual check without any optical instruments as a reference. Therefore, the calibration quality and uniformity of each monitor are difficult to control. Thus, some users purchase optical inspection equipment such as a color meter to perform the calibration. The optical color value of the image in the display unit is compared with the standard value so as to perform calibration of image parameters. This type of equipment, however, is still prohibitively expensive and is currently unable to automatically and fully compare or convert the image parameters of different settings. Moreover, most color meters may attenuate faster than the display units. Thus, users first need to send the color meter back to the company for calibration and then users are able to use the color meter to adjust the brightness and colors of the display unit. This is quite inconvenient and not very efficient.

Referring to U.S. Pat. No. 6,448,550 and Taiwanese Pat. Pub. No. 1263754, sensing units are built in a display for feedback control of brightness of light sources so as to compensate brightness of screens automatically. By adding the sensing unit to the design, related processing units of the display will get the brightness of the light source and be able to compare the brightness value of factory settings so as to perform brightness compensation (such as adjusting the driving current output to the lamp). Thus, the sensing unit used to perform brightness compensation must be sold with the display so as to perform the calibration and compensation of the brightness to have a uniform standard. Yet the cost is increased by adding the sensing unit. Once the sensing unit is out of order or the warranty expires, the entire display needs to be returned to the factory. Moreover, the above design is applied only to brightness adjustment of the display. Thus, there is a need to provide a convenient compensation system that addresses these problems while executing the adjustment of brightness and color compensation of the current display device.

### SUMMARY OF THE INVENTION

The primary object of the invention provides an efficient, convenient, and precise color compensation system to solve the attenuation problem of display devices. This invention provides a color compensation to adjust the displays for maintaining brightness and chromaticity just like factory settings, maintaining the requirement of display color standards, or maintaining preference color settings of users. In order to achieve the above object, a color compensation system for display devices of the present invention includes a server end and a user end which are connected together by a transmission medium. The server end consists of a plurality of server-end display devices, a first processing unit electrically or optically connected to the server-end display devices, and a first storage unit electrically or optically connected to the first processing unit. Each server-end display device is electrically or optically connected to an optical measuring device for measuring image signal parameters of the server-end display device and transmitting the image signal parameters to the first processing unit. The image signal parameters include spectrum, color, optical deviation, brightness, contrast ratio, color temperature, grey level, etc. The image signal parameters also include corresponding time markers. Moreover, the first processing unit contains an image signal adjustment module. The image signal adjustment module calculates and outputs image signal compensation parameters to the first storage unit according to the time markers of the image signal parameters. The image signal compensation parameters can be back light parameter, brightness, contrast ratio, color temperature, grey level, Gamma, RGB gain and RGB offset, saturation, hue, color intensity, color compensation parameter, color conversion parameter, color conversion formula, etc. The user end consists of at least one user-end display device having a second processing unit. The second processing unit receives image signal compensation parameters through the transmission medium so as to perform compensation and adjustment of image signal changes caused by attenuation of the user-end display device.

Furthermore, the user-end display device receives the image signal compensation parameters in a passive mode or an active mode. The image signal compensation parameters are transmitted to the second processing unit of the user-end display device through the transmission medium in the passive mode while the second processing unit receives the image signal compensation parameters from the server end through the transmission medium in the active mode. The second processing unit of the user-end display device then receives the image signal compensation parameters through the transmission medium in a passive mode or in an active mode so as to perform compensation and adjustment of the image signal changes caused by attenuation of the user-end display device. Thus, the display device is automatically calibrated and adjusted to keep color uniformity. This is the criteria to maintain brightness and chromaticity synonymous with factory settings, maintaining the requirement of display color standards, or maintaining the preference color settings of users. In order to avoid trouble and inconvenience of manual calibration, the compensation and adjustment are automatically executed by the second processing unit of the user-end display device.

One of the examples using a color compensation system is as follows: a user-end processor that is electrically or optically connected to the user-end display device is arranged between the user-end display device and the transmission medium, so the image signal compensation parameters in the first storage unit is transmitted to the user-end processor through the transmission medium. When the user-end processor is electrically or optically connected to a plurality of user-end display devices, the image parameters (such as brightness, color, etc.) of the plurality of the user-end display devices are directly compensated and adjusted automatically. Thus, each user-end display device gets a uniform calibration base. Another example using a color compensation system is as follows: the user-end display device includes a second storage unit electrically or optically connected to the second processing unit. The second storage unit receives the image signal compensation parameters and provides the image signal compensation parameters to the second processing unit through the transmission medium. In this way, the second processing unit performs compensation and adjustment of image signal changes. The image signal compensation parameters saved in the first storage unit can then be transmitted to the second storage unit by e-mails, file formats or storage media so as to avoid failure of the second processing unit in executing the adjustment and compensation due to an absence of networks or instability/or abnormality of the networks. Another example using the color compensation system is as follows: the image signal adjustment module can be installed on the user-end processor. The server end includes a plurality of server-end display devices and a first storage unit electrically or optically connected to the server-end display devices. Each server-end display device is electrically or optically connected to an optical measuring device. The optical measuring device is used for measuring and transmitting image signal parameters of the connected server-end display device to the first storage unit. The image signal parameters include corresponding time markers. As to the user end, it consists of a user-end processor and at least one user-end display device electrically or optically connected to the user-end processor. The user-end processor has an image signal adjustment module for calculation and generation of image signal compensation parameters according to the time markers of the image signal parameters. The user-end display device includes a second processing unit that performs compensation and adjustment of the image signal changes caused by attenuation of the user-end display device according to the image signal compensation parameters. Another example using a color compensation system is as follows: the image signal adjustment module is installed in the user-end display device. The user-end includes at least one user-end display device. The user-end display device has a second processing unit and an image signal adjustment module electrically or optically connected to the second processing unit. Moreover, the user-end display device is further electrically or optically connected to a user-end processor for receiving the image signal parameters through the transmission medium, and then the image signal adjustment module of the user-end display device is able to generate image signal compensation parameters according to the image signal parameters.

### BRIEF DESCRIPTION OF THE DRAWINGS

FIG. 1 is a block diagram showing electrical connections of a first embodiment of a color compensation system for display devices according to this invention;

FIG. 2 is a block diagram showing electrical connections of a second embodiment of a color compensation system for display devices according to this invention;

FIG. 3 is a block diagram showing electrical connections of a third embodiment of a color compensation system for display devices according to this invention;

FIG. 4 is a block diagram showing electrical connections of a fourth embodiment of a color compensation system for display devices according to this invention;

FIG. 5 is a block diagram showing electrical connections of a fifth embodiment of a color compensation system for display devices according to this invention;

FIG. 6 is a block diagram showing electrical connections of a sixth embodiment of a color compensation system for display devices according to this invention;

FIG. 7 is a block diagram showing electrical connections of a seventh embodiment of a color compensation system for display devices according to this invention;

FIG. 8 is a block diagram showing electrical connections of an eighth embodiment of a color compensation system for display devices according to this invention.

### DETAILED DESCRIPTION OF THE PREFERRED EMBODIMENT

In the following embodiments, an electrical or optical connection between a device and a unit, a device and a device, or a unit and a unit, can be done in a wired or a wireless way.

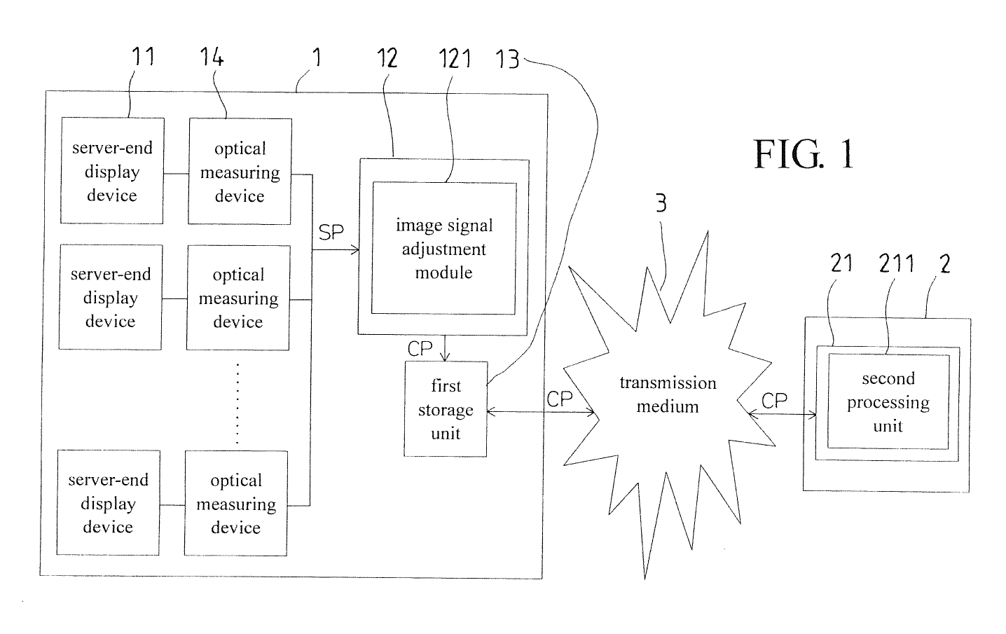

Referring to FIG. 1, a server-end display device 11 and a user-end display device 21 can be a television, a projector, a display, a hand-held device, a mobile device etc. A first processing unit 12, a second processing unit 211, can be a computer system, a disk player, a microprocessor, an embedded system, etc. A color compensation system for display device includes a server end 1 and a user end 2. The server end 1 consists of a first processing unit 12 electrically or optically connected to a plurality of the server-end display devices 11. Then, a first storage unit 13 is electrically or optically connected to the first processing unit 12. Each server-end display device 11 is electrically or optically connected to a plurality of corresponding optical measuring devices 14. The optical measuring device 14 can be a colorimeter, a spectrometer, etc., and can be built in or externally connected to a server-end display device 11. The optical measuring device 14 can be used in measurement of image signal parameters (SP) of the connected server-end display device 11 and output of the image signal parameters (SP) to the first processing unit 12. The image signal parameters (SP) includes spectrum, color, optical deviation, brightness, contrast ratio, color temperature, grey level, etc. The image signal parameters (SP) also include corresponding time markers. An image signal adjustment module 121 included in the first processing unit 12 calculates and outputs image signal compensation parameters (CP) to the first storage unit 13 according to the time markers of the image signal parameters (SP). The time markers of the image signal parameters (SP) are obtained from the internal timer of the server-end display device 11 or timer of the first processing unit 12, but not limited hereto. Moreover, the image signal compensation parameters (CP) can be attributed to back light parameter, brightness, contrast ratio, color temperature, grey level, Gamma, RGB gain and RGB offset, saturation, hue, color intensity, color compensation parameters, color conversion parameters, or a color conversion formula.

Further, the user end 2 is connected to the server end 1 by transmission medium 3. The user end 2 includes at least one user-end display device 21 while the user-end display device 21 has a second processing unit 211 thereof. The second processing unit 211 receives the image signal compensation parameters (CP) through the transmission medium 3 so as to perform compensation and adjustment of the image signal changes caused by attenuation of the user-end display device 21. The transmission medium 3 can be an internet, an intranet or a portable storage device (e.g., USB flash drive or portable hard disc drive) while a network is preferred.

Moreover, the user-end display device 21 can receive the image signal compensation parameters (CP) in a passive mode or in an active mode. In the passive mode, the image signal compensation parameters (CP) are transmitted to the second processing unit 211 of the user-end display device 21 through the transmission medium 3 while the second processing unit 211 receives the image signal compensation parameters (CP) from the server end 1 through the transmission medium 3 in the active mode. A trigger condition for the color compensation of the user-end display device 21 can be a manual triggering of a component, such as a button on the user-end display device 21 by users. While the first embodiment of the current invention is in use, each optical measuring device 14 electrically or optically connected to the corresponding server-end display device 11 detects the image signal parameters (SP) in the server-end display device 11 and outputs the image signal parameters (SP) to the first processing unit 12 at a certain interval (e.g., 10 min.). Due to corresponding time markers contained in the image signal parameters (SP), the image signal adjustment module 121 calculates and determines whether to output image signal compensation parameters (CP) to the first storage unit 13, after a preset/auto-determined compensation cycle (such as an hour) according to statistical relationship between the image signal parameters (SP) and time. Also, the first processing unit 12 and the first storage unit 13 can be integrated into a computer system. For example, it knows that the brightness (or other optical properties of the server-end display device 11, such as contrast ratio, color temperature, grey level, and so on.) of the server-end display device 11 is attenuated 1% in comparison with the factory setting according to the statistical relationship between the image signal parameters (SP) and time after 24 hours; wherein, the statistical relationship between the image signal parameters (SP) and time is linear. Thus, the image signal adjustment module 121 enables output of the image signal compensation parameters (CP) whose value equals to the factory setting brightness×1.01 to the first storage unit 13. It should be noted that not only can the optical measuring device 14 measure the image signal parameters (SP) of the server-end display device 11 at a certain interval such as 10 min, the first processing unit 12 also can detect whether the server-end display device 11 changes, further measures the image signal parameters (SP) of the server-end display device 11, and output the image signal parameters (SP) to the first processing unit 12. There is no restriction or limitations on optical measuring device 14. Moreover, the calculation for the compensation of the above image signal adjustment module 121 is already known, not the feature of the present invention, and is not limited by the way mentioned above. For example, the compensation calculation is performed by utilizing the extrapolation method and the interpolation method with a linear function of statistical relationship between the image signal parameters (SP) and time, or performing the extrapolation method and the interpolation method with a non-linear function of statistical relationship between the image signal parameters (SP) and time. People skilled in the art know a plurality of calculations for compensation of the image signal adjustment module 121. Next, the second processing unit 211 of the user-end display device 21 receives the image signal compensation parameters (CP) through the transmission medium 3 in a passive mode or in an active mode for performing compensation and adjustment of the image signal changes caused by attenuation of the user-end display device 21. In such a way, the brightness of the user-end display device 21 is adjusted to 1.01 times of the factory setting brightness by means of the image signal compensation parameters (CP). Not only is the cost of the color meter saved, the second processing unit 211 of the user-end display device 21 also automatically performs the calibration, thus rendering unnecessary a manual calibration of the display.

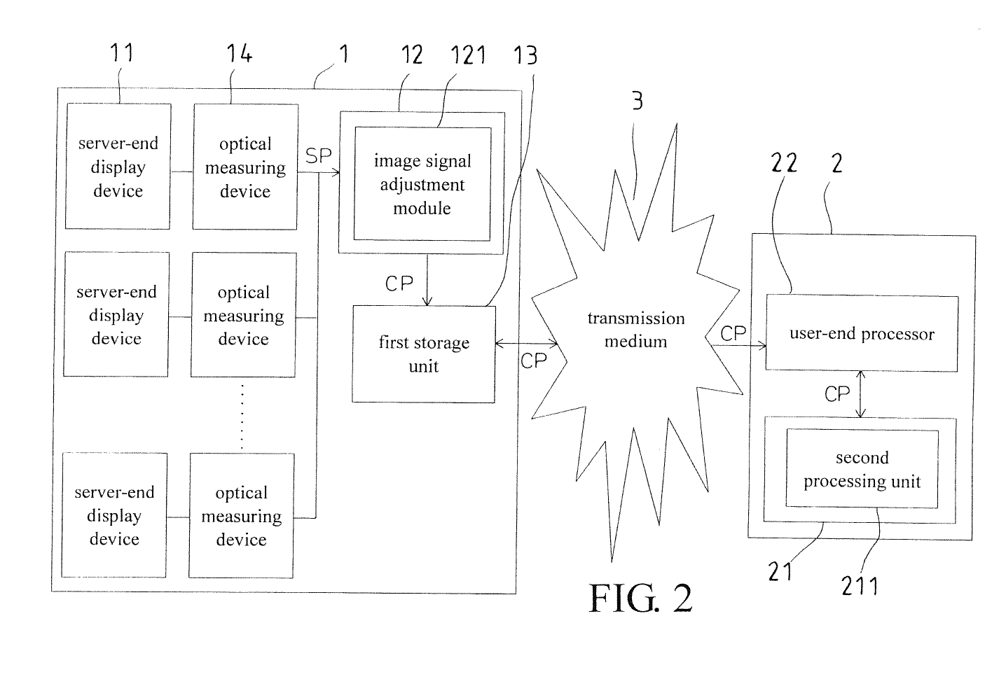

Referring to FIG. 2, a server-end display device 11 and a user-end display device 21 can be a television, a projector, a display, a hand-held device, a mobile device, etc. A first processing unit 12 and a second processing unit 211, can be a computer system, a disk player, a microprocessor, an embedded system, etc. The difference between this embodiment and the first embodiment lies in a user-end processor included in this embodiment. The user-end processor (e.g., a computer system) is electrically or optically connected to the user-end display device 21 as well as arranged between the user-end display device 21 and the transmission medium 3. The image signal compensation parameters (CP) in the first storage unit 13 is first transmitted to the user-end processor 22 through the transmission medium 3 and then the user-end display device 21 acquires the image signal compensation parameters (CP) in a passive or active mode.

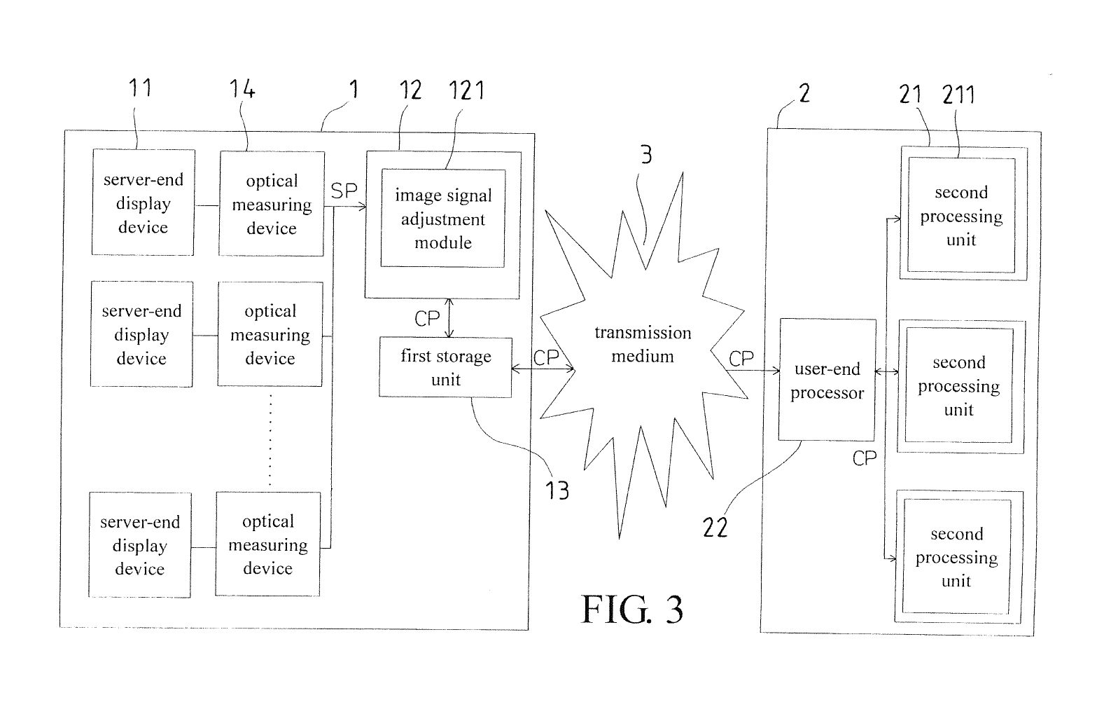

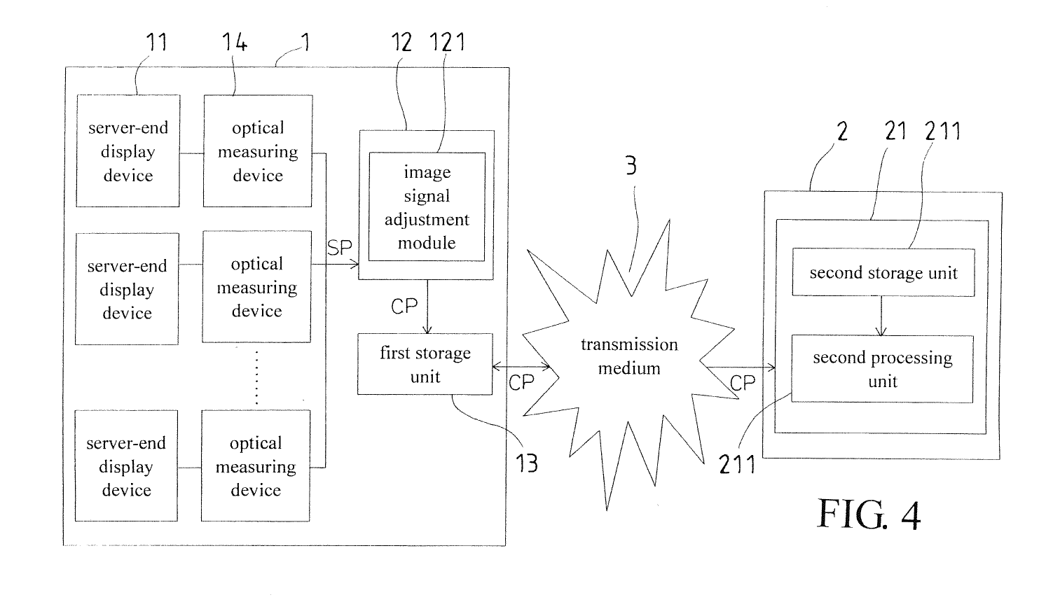

Referring to FIG. 3, a further embodiment is disclosed. The image parameter (e.g. brightness, color, etc.) of the plurality of the user-end display devices 21 can be automatically compensated and adjusted to get a uniform calibration base by electrical or optical connection of the user-end processor 22 (such as a computer server system) to a plurality of user-end display devices 21. As a result, the difference between compensation values of the user-end display devices 21 caused by errors of manual calibration of the color meter can be avoided. Referring to FIG. 4, a fourth embodiment is revealed. The difference between this embodiment and the first embodiment lies in a second storage unit included in the user-end display device 21. The second storage unit 212 is electrically or optically connected to the second processing unit 211 and enables reception of the image signal compensation parameters (CP) through the transmission medium 3, so that the second processing unit 211 can perform compensation and adjustment of image signal change. The image signal compensation parameters (CP) saved in the first storage unit (13) can be transmitted to the second storage unit 212 by e-mails, file formats or storage media so as to avoid failure of the second processing unit 211 in executing the adjustment and compensation due to an absence of networks or instability/or abnormality of the networks.

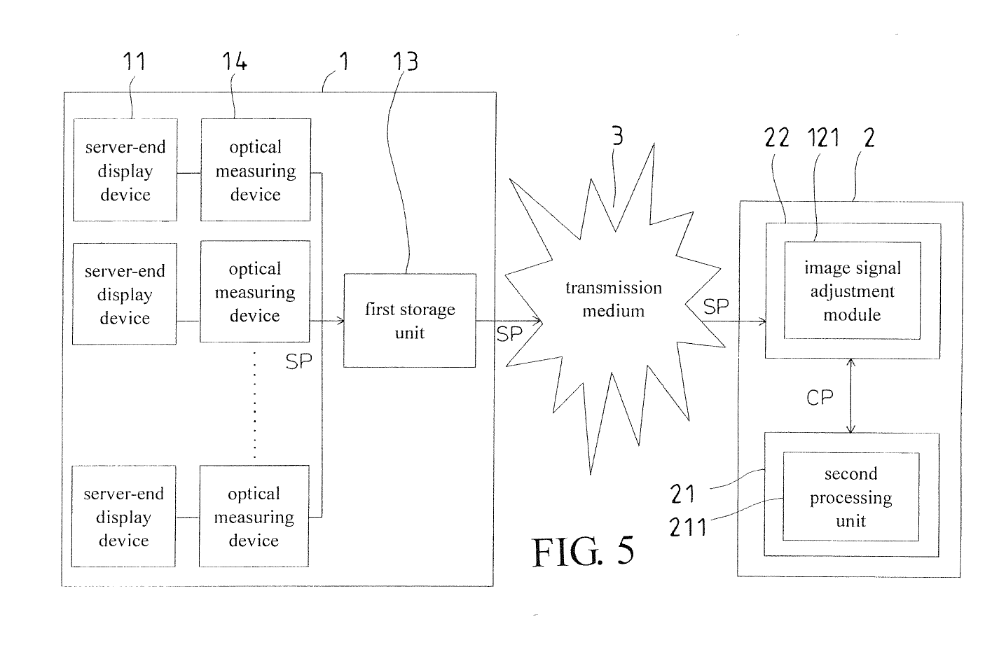

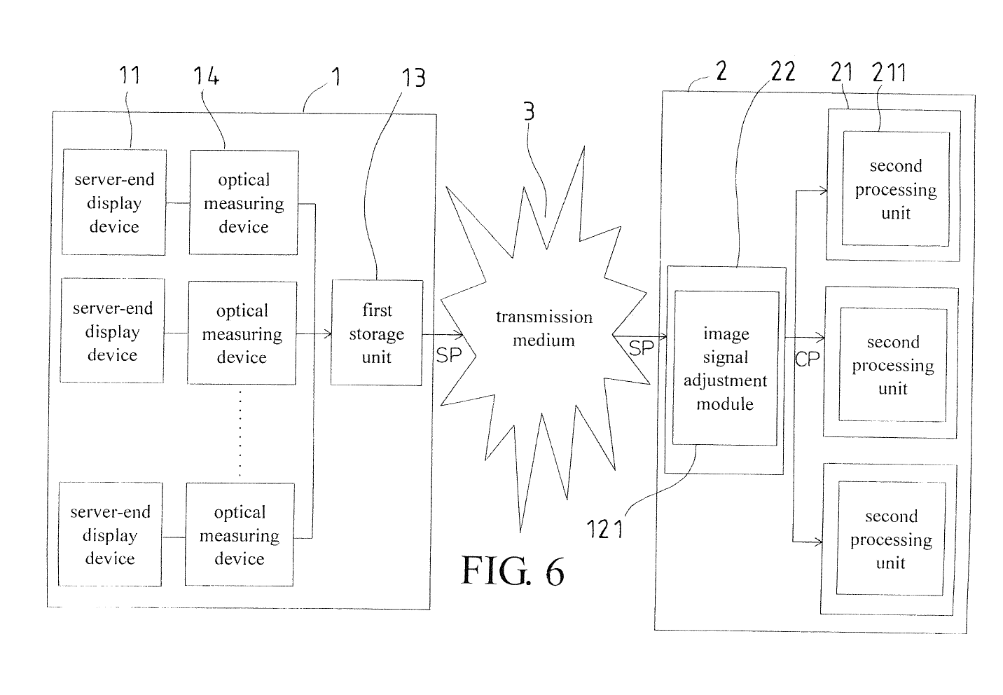

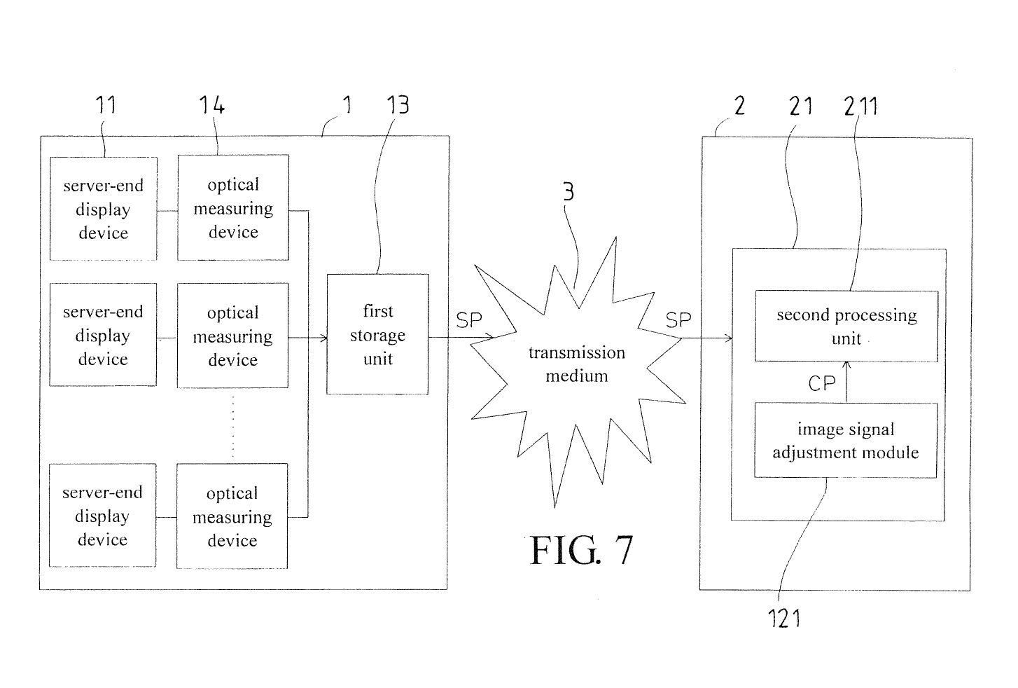

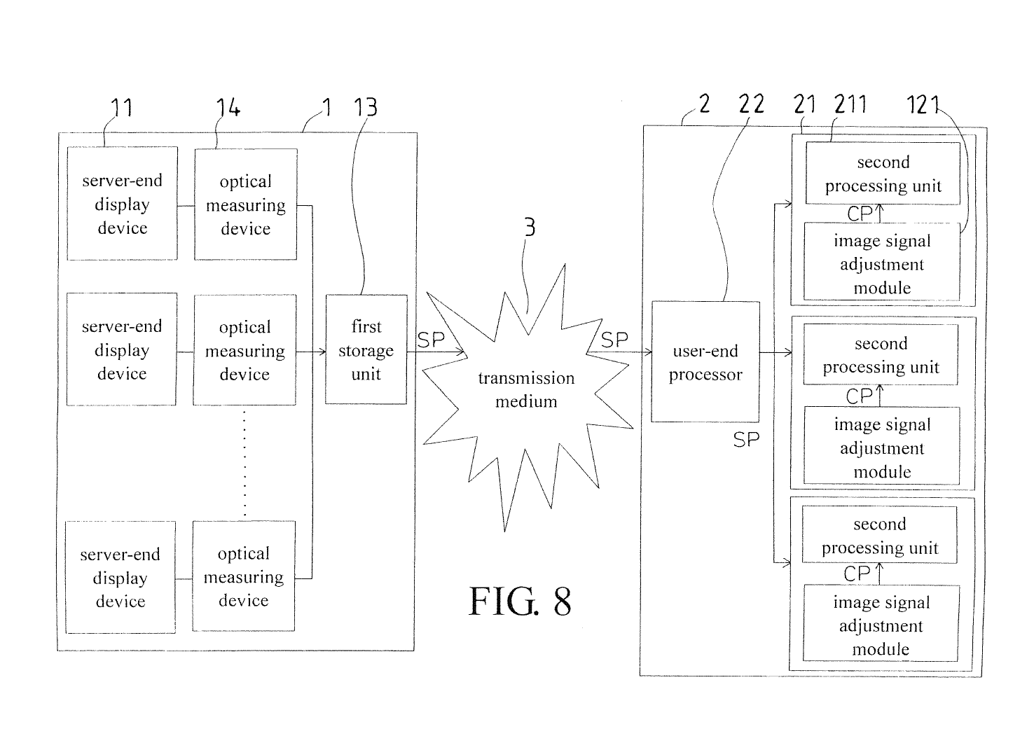

Referring to FIG. 5, a fifth embodiment of the current invention, as shown in FIG. 5, reveals that the image signal adjustment module 121 can also be arranged in the user-end processor (processing device) 22 at the user end 2. A system of this embodiment includes a server end 1 and a user end 2. The server end 1 consists of a plurality of server-end display devices 11, a first storage unit 13 electrically or optically connected to the server-end display devices 11, and a plurality of optical measuring devices 14. Each server-end display device 11 is electrically or optically connected to one of corresponding optical measuring devices 14. The optical measuring device 14 is used to measure image signal parameters (SP) of the connected server-end display device 11 and also transmits the image signal parameters (SP) to the first storage unit 13. The image signal parameters (SP) also include corresponding time markers. The user end 2 is connected to the server end 1 by transmission medium 3. The user end 2 includes a user-end processor 22 and at least one user-end display device 21 electrically or optically connected to the user-end processor 22. The user-end processor 22 includes an image signal adjustment module 121 for calculation and generation of image signal compensation parameters (CP) according to the time markers of the image signal parameters (SP). The user-end display device 21 includes a second processing unit 211 to perform compensation and adjustment of the image signal changes caused by attenuation of the user-end display device 21 according to the image signal compensation parameters (CP). The user-end display device 21 receives the image signal compensation parameters (CP) in a passive mode or in an active mode. In the passive mode (e.g., a system manager of the user-end processor 22 giving instructions), the user-end processor 22 sends the image signal compensation parameters (CP) to the second processing unit 211 of the user-end display device 21. In the active mode, the second processing unit 211 collects the image signal compensation parameters (CP) from the user-end processor 22. The trigger condition of the color compensation of the user-end display device 21 can be the manual triggering of a button of the user-end display device 21 by users, automatic triggering of the user-end processor 22 at a certain interval, or automatic checking whether the condition for compensation is satisfied by the user-end processor 22. It should be noted that the way of the optical measuring device 14 to measure and transmit image signal parameters (SP) of the server-end display device 11 to the first storage unit 13, the way and effects for generation of the image signal compensation parameters (CP) by the image signal adjustment module 121 according to the image signal parameters (SP) are the same with the embodiment as mentioned in FIG. 1. Referring to FIG. 6, the user-end processor 22 is electrically or optically connected to a plurality of user-end display devices 21 so as to make an automatic compensation and adjustment of image parameters (such as the brightness and colors, etc.) of the user-end display devices 21. Thus, each user-end display device 21 allows acquisition of a uniform calibration base. Still, the image signal adjustment module 121 can also be installed in the user-end display device 21 at the user end 2. Referring to FIG. 7, a seventh embodiment of a system according to the current invention is revealed. The system of the present invention includes a server end 1 and a user end 2. The server end 1 consists of a plurality of server-end display devices 11, each of which is electrically or optically connected to an optical measuring device 14, and a first storage unit 13 electrically or optically connected to the server-end display devices 11. The optical measuring device 14 measures image signal parameters (SP) of the connected server-end display device 11 and transmits the image signal parameters (SP) to the first storage unit 13. The image signal parameters (SP) also include corresponding time markers. The user end 2 is electrically or optically connected to the server end 1 through a transmission medium 3. The user end 2 includes at least one user-end display device 21. The user-end display device 21 has a second processing unit 211 and an image signal adjustment module 121 electrically or optically connected to the second processing unit 211. Thus, the image signal adjustment module 121 enables the calculation and generation of image signal compensation parameters (CP) in accordance with time markers of the image signal parameters (SP). Then, the second processing unit 211 is able to perform compensation and adjustment of the image signal changes caused by attenuation of the user-end display device 21 according to the image signal compensation parameters (CP). The way for transmission of image signal parameters by the optical measuring device 14, the way and effects for generation of the image signal compensation parameters (CP) by the image signal adjustment module 121 according to the image signal parameters, are all the same with the fifth embodiment shown in FIG. 5. At last, the difference between the eighth embodiment shown in FIG. 8 and the seventh embodiment lies in the electrical or optical connection of the user-end display device 21 to a user-end processor 22, which allows the reception of the image signal parameters (SP) through the transmission medium 3. It is likely that the image signal adjustment module 121 of the user-end display device 21 allows the generation of image signal compensation parameters (CP) according to the image signal parameters (SP). The user-end display device 21 can receive the image signal compensation parameters (CP) in a passive mode or an active mode. In the passive mode (e.g., a system manager of the user-end processor 22 giving instructions) the user-end processor 22 is able to send the image signal compensation parameters (CP) to the user-end display device 21. While in the active mode, the user-end display device 21 collects the image signal compensation parameters (CP) from the user-end processor 22. The trigger condition for the color compensation of the user-end display device 21 can be the manual triggering of a button of the user-end display device 21 by users, triggering by the user-end processor 22 at a certain interval, or automatic checking of whether the condition for compensation is satisfied by the user-end processor 22. Additional advantages and modifications will readily occur to those skilled in the art. Therefore, the invention in its broader aspects is not limited to the specific details, and representative devices shown and described herein.

Accordingly, various modifications may be made without departing from the spirit or scope of the general inventive concept as defined by the appended claims and their equivalents.

What is claimed is:

1. A color compensation system for display devices, comprising: a server end having a plurality of server-end display devices, a first processing unit electrically or optically connected to the server-end display devices, and a first storage unit electrically or optically connected to the first processing unit while each server-end display device is electrically or optically connected to an optical measuring device that outputs image signal parameters of the server-end display device to the first processing unit; the image signal parameters include corresponding time markers; the first processing unit includes an image signal adjustment module that calculates and outputs image signal compensation parameters to the first storage unit according to the time markers of the image signal parameters; and
a user end which is electrically or optically connected to the server end by a transmission medium have at least one user-end display device which includes a second processing unit; the second processing unit receives the image signal compensation parameters through the transmission medium so as to perform compensation and adjustment of image signal changes caused by attenuation of the user-end display device.

2. The system as claimed in claim 1, wherein the user-end display device receives the image signal compensation parameters in a passive mode or in an active mode; the image signal compensation parameters are transmitted to the second processing unit of the user-end display device through the transmission medium in the passive mode, while the second processing unit of the user-end display device retrieves the image signal compensation parameters from the server end through the transmission medium in the active mode.

3. The system as claimed in claim 1, wherein the image signal parameters are selected from the group consisting of spectrum, color, optical deviation, brightness, contrast ratio, color temperature, and grey level.

4. The system as claimed in claim 1, wherein the image signal compensation parameters are selected from the group consisting of back light parameter, brightness, contrast ratio, color temperature, grey level, Gamma, RGB gain and RGB offset, saturation, hue, color intensity, color compensation parameters, color conversion parameters, and color conversion formula.

5. The system as claimed in claim 1, wherein a user-end processor being electrically or optically connected to the user-end display device is further arranged between the user-end display device and the transmission medium; the image signal compensation parameters in the first storage unit are transmitted to the user-end processor through the transmission medium.

6. The system as claimed in claim 1, wherein the user-end display device further includes a second storage unit electrically or optically connected to the second processing unit; the second storage unit receives the image signal compensation parameters through the transmission medium and provides the image signal compensation parameters to the second processing unit so that the second processing unit performs compensation and adjustment while image signal changes.

7. A color compensation system for display devices comprises:
a server end having a plurality of server-end display devices and a first storage unit electrically or optically connected to the server-end display devices while each server-end display device is electrically or optically connected to an optical measuring device that outputs image signal parameters of the connected server-end display device to the first storage unit; the image signal parameters include corresponding time markers; and
a user end being electrically or optically connected to the server end by a transmission medium and having a user-end processor and at least one user-end display device electrically or optically connected to the user-end processor; the user-end processor includes an image signal adjustment module that calculates and generates image signal compensation parameters according to the time markers of the image signal parameters; the user-end display device includes a second processing unit that performs compensation and adjustment of image signal changes caused by attenuation of the user-end display device according to the image signal compensation parameters.

8. The system as claimed in claim 7, wherein the user-end display device receives the image signal compensation parameters in a passive mode or in an active mode; the user-end processor transmits the image signal compensation parameters to the second processing unit of the user-end display device in the passive mode, while the second processing unit retrieves the image signal compensation parameters from the user end processor in the active mode.

9. The system as claimed in claim 7, wherein the image signal parameters are selected from the group consisting of spectrum, color, optical deviation, brightness, contrast ratio, color temperature, and grey level.

10. The system as claimed in claim 7, wherein the image signal compensation parameters are selected from the group consisting of back light parameter, brightness, contrast ratio, color temperature, grey level, Gamma, RGB gain and RGB offset, saturation, hue, color intensity, color compensation parameters, color conversion parameters, and color conversion formula.

11. A color compensation system for display devices comprising
a server end having a plurality of server-end display devices and a first storage unit electrically or optically connected to the server-end display devices while each server-end display device is electrically or optically connected to an optical measuring device that outputs image signal parameters of the connected server-end display device to the first storage unit; the image signal parameters include corresponding time markers; and
a user end being electrically or optically connected to the server end by a transmission medium and having at least one user-end display device while the user-end display device includes a second processing unit and an image signal adjustment module electrically or optically connected to the second processing unit; the image signal adjustment module calculates and generates image signal compensation parameters according to the time markers of the image signal parameters; the second processing unit performs compensation and adjustment of image signal changes caused by attenuation of the user-end display device according to the image signal compensation parameters.

12. The system as claimed in claim 11, wherein the user-end display device is electrically connected to a user-end processor; the user-end processor receives the image signal parameters through the transmission medium; the image signal adjustment module of the user-end display device generates image signal compensation parameters according to the image signal parameters.

13. The system as claimed in claim 12, wherein the user-end display device receives the image signal compensation parameters in a passive mode or in an active mode; the user-end processor transmits the image signal compensation parameters to the user-end display device in the passive mode, while the user-end display device retrieves the image signal compensation parameters from the user end processor in the active mode.

14. The system as claimed in claim 11, wherein the image signal parameters are selected from the group consisting of spectrum, color, optical deviation, brightness, contrast ratio, color temperature, and grey level.

15. The system as claimed in claim 11, wherein the image signal compensation parameters are selected from the group consisting of back light parameter, brightness, contrast ratio, color temperature, grey level, Gamma, RGB gain and RGB offset, saturation, hue, color intensity, color compensation parameters, color conversion parameters, and color conversion formula.
